(19) United States
(12) Patent Application Publication
(10) Pub. No.: US 2014/0218669 A1
(43) Pub. Date: Aug. 7, 2014

(54) DISPLAY PANEL AND DISPLAY DEVICE

(71) Applicant: BOE TECHNOLOGY GROUP CO., LTD., Beijing (CN)

(72) Inventors: TERUAKI SUZUKI, Beijing (CN); YAFENG YANG, Beijing (CN); KIMAN KIM, Beijing (CN)

(73) Assignee: BOE TECHNOLOGY GROUP CO., LTD., Beijing (CN)

(21) Appl. No.: 14/098,917

(22) Filed: Dec. 6, 2013

(30) Foreign Application Priority Data
Dec. 7, 2012 (CN) 201210526435.0

(51) Int. Cl. G02F 1/13363

(52) U.S. Cl. CPC G02F 1/13363
USPC 349/102; 349/96

(57) ABSTRACT

A display panel and a display device are disclosed. The display panel comprises a lower substrate, an upper substrate and a liquid crystal layer disposed between the upper substrate and the lower substrate, a lower polarizer is disposed at a light incident side of the lower substrate, an upper polarizer is disposed at a light exiting side of the upper substrate. The display panel further comprises a compensation layer disposed between the upper substrate and the liquid crystal layer and configured for converting a polarization direction of light exiting the upper substrate to the same as the polarization direction of light before incident on the lower substrate.

### FIELD OF THE ART

Embodiments of the invention relate to the technical field of liquid crystal displays, more particularly, to a display panel and a display device.

### BACKGROUND

Liquid Crystal Display (LCD) devices have the advantages of having light weight, small thickness, lower power consumption and little radiation and so on and have been widely used in the fields of information technology, multimedia technologies etc. and are gradually become mainstream display for various display devices. With the development of display technologies, the future trend of LCDs is high transmittivity, large scale, lower power consumption and low cost.

A configuration of a LCD panel is illustrated in FIG. 1, which comprises a lower substrate I (e.g. a glass substrate), an upper substrate 2 (e.g. a glass substrate) and a liquid crystal layer 3 filled between the two substrates. The lower substrate 1 and/or the upper substrate 2 has a transparent electrode layer formed thereon. A lower polarizer 4 is disposed on a light incident side of the lower substrate 1, an upper polarizer 5 is disposed on a light exiting side of the upper substrate 2. As illustrated by the solid arrows in FIG. 1, absorbing axes of the lower and upper polarizers 4 and 5 are orthogonal to each other (being 0 degree and 90 degrees respectively). When no electric field is applied, light is incident from the lower polarizer 4 and a linearly polarized light is produced, with the polarization direction rotated by 90 degrees by the liquid crystal molecules, and then the light exits from the upper polarizer 5. At this point, the display panel renders the white background color. When an electric field is applied, the arrangement of the liquid crystal molecules is changed, and the linearly polarized light passes through the liquid crystal layer 3 without changing its polarization direction and is then absorbed by the upper polarizer 5, making it impossible to be transmitted. As a result, the display panel is black.

The display quality of the LCD is directly related to the brightness of the bright state and the dark state. For a high contrast ratio, theoretically it is supposed to achieve an all-dark state with very low brightness. However, in fact, as illustrated in FIG. 2, twist and deformation of the upper and lower glass substrates may cause the retardation amount of the polarized light passing through the glass substrate to change (the solid arrows in the upper and lower substrates 1, 2 of FIG. 2 illustrate the direction of the retardation amount caused by glass deformation), thereby causing uneven dark state of the LCD. When the linearly polarized light passes through the upper glass substrate 2, its polarization state is different from before incident on the lower glass substrate I. As a result, the light is not totally absorbed by the upper polarizer 5 and a part of light is transmitted as illustrated by the dotted arrow in the figure, causing light leakage in the dark state and uneven display.

### SUMMARY

The invention provides a display panel and a display device that can prevent light leakage in the dark state and uneven display caused by the deformation of the glass substrate.

A first aspect of the invention provides a display panel, comprising a lower substrate, an upper substrate and a liquid crystal layer disposed between the upper substrate and the lower substrate, a lower polarizer is disposed at a light incident side of the lower substrate, an upper polarizer is disposed at a light exiting side of the upper substrate, the display panel further comprises a compensation layer disposed between the upper substrate and the liquid crystal layer and configured for converting a polarization direction of light exiting the upper substrate to the same as the polarization direction of light before incident on the lower substrate.

As an example, long axis of liquid crystal molecules in the liquid crystal layer is the same as absorbing axis of the upper polarizer or the lower polarizer.

As an example, slow axis of the compensation layer is orthogonal to the long axis of the liquid crystal molecules in the liquid crystal layer, and a retardation amount of the compensation layer is the same as that of the liquid crystal layer.

As an example, slow axis of the compensation layer is in the same direction as the long axis of the liquid crystal molecules in the liquid crystal layer, and a sum of a retardation amount of the compensation layer and a retardation amount of the liquid crystal molecules is equal to a primary wavelength of incident light of the display panel.

As an example, the primary wavelength is 400-700 nm.

As an example, the display panel further comprises a transparent electrode layer disposed on the light exiting side of the lower substrate and/or the light incident side of the upper substrate.

As an example, the compensation layer is made of cyclic olefin polymers macromolecular material, polycarbonates macromolecular material, polystyrenes macromolecular material or liquid crystal macromolecular material.

A second aspect of the invention provides a display device comprising the above display panel.

### BRIEF DESCRIPTION OF THE DRAWINGS

In order to clearly illustrate the technical solution of the embodiments of the invention, the drawings of the embodiments will be briefly described in the following; it is obvious that the described drawings are only related to some embodiments of the invention and thus are not limitative of the invention.

FIG. 1 schematically illustrates a configuration of a conventional LCD panel;

FIG. 2 schematically illustrates the principle of light leakage caused by glass deformation of the display panel of FIG. 1;

FIG. 3 schematically illustrates a configuration of a display panel of Example 1;

FIG. 4 schematically illustrates the principle of dark state of the display panel of Example 1; and

FIG. 5 schematically illustrates the principle of dark state of a display panel of Example 2.

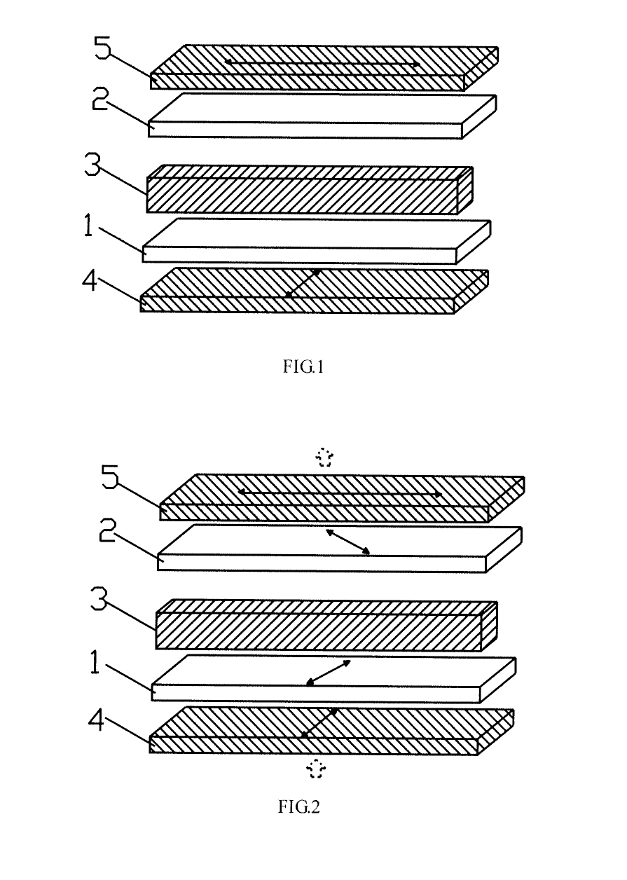

### DETAILED DESCRIPTION

In order to make objects, technical details and advantages of the embodiments of the invention apparent, the technical solutions of the embodiment will be described in a clearly and fully understandable way in connection with the drawings related to the embodiments of the invention. It is obvious that the described embodiments are just a part but not all of the embodiments of the invention. Based on the described embodiments herein, those skilled in the art can obtain other embodiment(s), without any inventive work, which should be within the scope of the invention.

In the drawings, solid arrows in polarizers represent directions of absorbing axis or transmission axis, solid arrows in liquid crystal layers represent directions of long axis of liquid crystal molecules, solid arrows in substrates represent retardation directions, and solid arrows in compensation layers represent slow axis thereof.

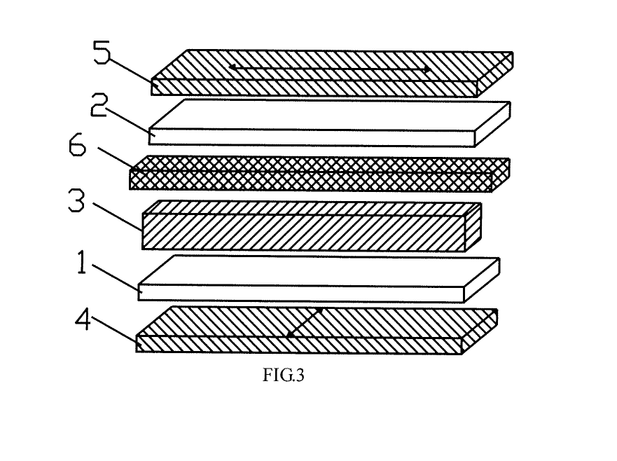

As illustrate in FIG. 3, a display panel in accordance with an embodiment of the invention comprises a lower substrate I, an upper substrate 2 and a liquid crystal layer 3 disposed between the upper and lower substrates 2 and 1; a lower polarizer 4 is disposed on a light incident side of the lower substrate 1, an upper polarizer 5 is disposed on a light exiting side of the upper substrate 2, and absorbing axes of the upper and lower polarizers 5 and 4 are orthogonal to each other. A transparent electrode layer (not shown) may also be disposed on light exiting side of the lower substrate 1 and/or light incident side of the upper substrate 2. The display panel further comprises a compensation layer 6 disposed between the upper substrate 2 and the liquid crystal layer 3. The compensation layer 6 is configured to convert a polarization direction of light exiting the upper substrate 2 to the same as the polarization direction of light before incident on the lower substrate 1, so as to effectively inhibit light leakage. For example, the compensation layer 6 may be made of macromolecular material, such as cyclic olefin polymers (COP), polycarbonates (PC) or polystyrenes (PS), etc, or liquid crystal macromolecular material.

In the following, the invention will be further described with reference to examples.

### Example 1

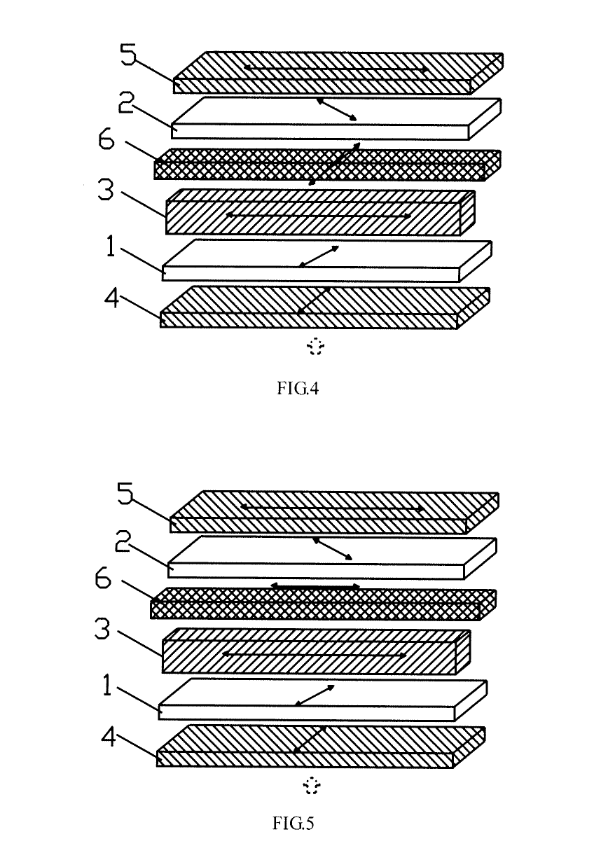

As illustrated in FIG. 4, in the example of the display panel, long axis of liquid crystal molecules in the liquid crystal layer 3 is the same as absorbing axis of the upper polarizer 5 (or the same as that of the lower polarizer 4). A retardation amount of the compensation layer 6 is the same as that of the liquid crystal layer 3, and slow axis of the compensation layer 6 is orthogonal to the long axis of the liquid crystal molecules in the liquid crystal layer 3, thereby converting polarization direction of light transmitted through the upper polarizer 2 to the same as polarization direction of the light before incident on the lower substrate I. As a result, incident light as indicated by dotted arrow is completely absorbed by the upper polarizer 5 and no light leakage will occur.

### Example 2

As illustrated in FIG. 5, in the display panel of the example, long axis of liquid crystal molecules in the liquid crystal layer 3 is still the same as absorbing axis of the upper polarizer 5. However, this example differs from example 1 in that slow axis of the compensation layer 6′ is in the same direction as the long axis of the liquid crystal molecules in the liquid crystal layer 3, and a sum of a retardation amount of the compensation layer 6′ and a retardation amount of the liquid crystal molecules is equal to a primary wavelength of incident light of the display panel, which is for example 400-700 nm, and typically 550 nm, thereby converting polarization direction of light transmitted through the upper polarizer 2 to the same as polarization direction of the light before incident on the lower substrate 1. As a result, incident light as indicated by dotted arrow is completely absorbed by the upper polarizer 5 and no light leakage will occur.

Another embodiment of the invention further provides a display device comprising the above display panel. The display device may be for example a display device comprises transparent electrode layers respectively disposed on light exiting side of the lower substrate and light incident side of the upper substrate, or an ADvanced Super Dimension Switch (ADS) display device with a transparent electrode layer disposed just on light exiting side of the lower substrate. Other components well known to those skilled in the art will not be described here and are not limitative to the technical solutions of the invention.

In summary, the display panel and display device of the invention converts polarization direction of light transmitted through the upper polarizer to the same as polarization direction of the light before incident on the lower substrate by disposing the compensation layer in the liquid crystal cell, thereby preventing light leakage in the dark state and uneven display caused by the deformation of the glass substrate. Meanwhile, the invention may minimize light leakage caused by glass substrate deformation under the condition of unchanging deformation property of the glass substrate.

What are described above is related to the illustrative embodiments of the disclosure only and not limitative to the scope of the disclosure; the scopes of the disclosure are defined by the accompanying claims.

What is claimed is:

1. A display panel, comprising a lower substrate, an upper substrate and a liquid crystal layer disposed between the upper substrate and the lower substrate, a lower polarizer is disposed at a light incident side of the lower substrate, an upper polarizer is disposed at a light exiting side of the upper substrate, the display panel further comprises a compensation layer disposed between the upper substrate and the liquid crystal layer and configured for converting a polarization direction of light exiting the upper substrate to the same as the polarization direction of light before incident on the lower substrate.

2. The display panel of claim 1, wherein long axis of liquid crystal molecules in the liquid crystal layer is the same as absorbing axis of the upper polarizer or the lower polarizer.

3. The display panel of claim 2, wherein slow axis of the compensation layer is orthogonal to the long axis of the liquid crystal molecules in the liquid crystal layer, and a retardation amount of the compensation layer is the same as that of the liquid crystal layer.

4. The display panel of claim 2, wherein slow axis of the compensation layer is in the same direction as the long axis of the liquid crystal molecules in the liquid crystal layer, and a sum of a retardation amount of the compensation layer and a retardation amount of the liquid crystal molecules is equal to a primary wavelength of incident light of the display panel.

5. The display panel of claim 4, wherein the primary wavelength is 400-700 nm.

6. The display panel of claim 1, further comprising a transparent electrode layer disposed on the light exiting side of the lower substrate and/or the light incident side of the upper substrate.

7. The display panel of claim 1, wherein the compensation layer is made of cyclic olefin polymers macromolecular material, polycarbonates macromolecular material, polystyrenes macromolecular material or liquid crystal macromolecular material.

8. The display panel of claim 2, wherein the compensation layer is made of cyclic olefin polymers macromolecular material, polycarbonates macromolecular material, polystyrenes macromolecular material or liquid crystal macromolecular material.

9. The display panel of claim 3, wherein the compensation layer is made of cyclic olefin polymers macromolecular material, polycarbonates macromolecular material, polystyrenes macromolecular material or liquid crystal macromolecular material.

10. The display panel of claim 4, wherein the compensation layer is made of cyclic olefin polymers macromolecular material, polycarbonates macromolecular material, polystyrenes macromolecular material or liquid crystal macromolecular material.

11. The display panel of claim 5, wherein the compensation layer is made of cyclic olefin polymers macromolecular material, polycarbonates macromolecular material, polystyrenes macromolecular material or liquid crystal macromolecular material.

12. The display panel of claim 6, wherein the compensation layer is made of cyclic olefin polymers macromolecular material, polycarbonates macromolecular material, polystyrenes macromolecular material or liquid crystal macromolecular material.

13. A display device comprising the display panel of claim 1.
